(19) United States
(12) Patent Application Publication
(10) Pub. No.: US 2026/0332922 A1
(43) Pub. Date: Oct. 22, 2026

(54) HIGH AVAILABILITY PON SYSTEM

(71) Applicant: ARRIS Enterprises LLC, Horsham, PA (US)

(72) Inventors: David BOWLER, Stow, MA (US); Shawn W. WARNER, Pepperell, MA (US)

(73) Assignee: ARRIS Enterprises LLC, Horsham, PA (US)

(21) Appl. No.: 19/105,774

(22) PCT Filed: May 18, 2023
(86) PCT No.: PCT/US2023/022768

§ 371 Date: Feb. 21, 2025

Related U.S. Application Data
(60) Provisional application No. 63/399,969, filed on Aug. 22, 2022.

(51) Int. Cl. H04Q 11/00

(52) U.S. Cl. CPC H04Q 11/0067; H04Q 2011/0083

(57) ABSTRACT

A system supporting high availability for a passive optical network.

### CROSS REFERENCE TO RELATED APPLICATIONS

The present application claims the benefit of U.S. Provisional Patent Application Ser. No. 63/399,969, filed Aug. 22, 2022.

### BACKGROUND

The subject matter of this application relates to high availability for passive optical networking.

A passive optical network (PON) is often employed as an access network, or a portion of a larger communication network. The communication network typically has a high-capacity core portion where data or other information associated with telephone calls, digital television, and Internet communications is carried substantial distances. The core portion may have the capability to interact with other networks to complete the transmission of telephone calls, digital television, and Internet communications. In this manner, the core portion in combination with the passive optical network enables communications to and communications from subscribers (or otherwise devices associated with a subscriber, customer, business, or otherwise).

The access network of the communication network extends from the core portion of the network to individual subscribers, such as those associated with a particular residence location (e.g., business location). The access network may be wireless access, such as a cellular network, or a fixed access, such as a passive optical network or a cable network.

Referring to FIG. 1, in a PON 10, a set of optical fibres and passive interconnecting devices are used for most or all of the communications through the extent of the access network. A set of one or more optical network terminals (ONTs) 11 are devices that are typically positioned at a subscriber's residence location (e.g., or business location). The term “ONT” includes what is also referred to as an optical network unit (ONU). There may be any number of ONTs associated with a single optical splitter 12. By way of example, 32 or 64 ONTs are often associated with the single network optical splitter 12. The optical splitter 12 is interconnected with the respective ONTs 11 by a respective optical fiber 13, or otherwise a respective fiber within an optical fiber cable. Selected ONTs may be removed and/or added to the access network associated with the optical splitter 12, as desired. There may be multiple optical splitters 12 that are arranged in a cascaded arrangement.

The optical fibers 13 interconnecting the optical splitter 12 and the ONTs 11 act as access (or “drop”) fibers. The optical splitter 12 is typically located in a street cabinet or other structure where one or more optical splitters 12 are located, each of which are serving their respective set of ONTs. In some cases, an ONT may service a plurality of subscribers, such as those within a multiple dwelling unit (e.g., apartment building). In this manner, the PON may be considered a point to multipoint topology in which a single optical fiber serves multiple endpoints by using passive fiber optic splitters to divide the fiber bandwidth among the endpoints.

An optical line terminal (OLT) 14 is located at the central office where it interfaces directly or indirectly with a core network 15. An interface 16 between the OLT 14 and the core network 15 may be one or more optical fibers, or any other type of communication medium. The OLT 14 forms optical signals for transmission downstream to the ONTs 11 through a feeder optical fiber 17, and receives optical signals from the ONTs 11 through the feeder optical fiber 17. The optical splitter 12 is typically a passive device that distributes the signal received from the OLT 14 to the ONTs 11. Similarly, the optical splitter 12 receives optical signals from the ONTs 11 and provides the optical signals though the feeder optical fiber 17 to the OLT 14. In this manner, the PON includes an OLT with a plurality of ONTs, which reduces the amount of fiber necessary as compared with a point-to-point architecture.

As it may be observed, an optical signal is provided to the feeder fiber 17 that includes all of the data for the ONTs 11. Accordingly, all the data being provided to each of the ONTs is provided to all the ONTs through the optical splitter 12. Each of the ONTs selects the portions of the received optical signals that are intended for that particular ONT and passes the data along to the subscriber, while discarding the remaining data. Typically, the data to the ONTs are broadcast to the feeder fiber 17 and provided to each of the ONTs.

Upstream transmissions from the ONTs 11 through the respective optical fibers 13 are typically transmitted in bursts according to a schedule provided to each ONT by the OLT. In this way, each of the ONTs 11 will transmit upstream optical data at different times. In some embodiments, the upstream and downstream transmissions are transmitted using different wavelengths of light so that they do not interfere with one another. In this manner, the PON may take advantage of wavelength-division multiplexing, using one wavelength for downstream traffic and another wavelength for upstream traffic on a single mode fiber.

The schedule from the OLT allocates upstream bandwidth to the ONTs. Since the optical distribution network is shared, the ONT upstream transmission would likely collide if they were transmitted at random times. The ONTs typically lie at varying distances from the OLT and/or the optical splitter, resulting in a different transmission delay from each ONT. The OLT measures the delay and sets a register in each ONT to equalize its delay with respect to the other ONTs associated with the OLT. Once the delays have been accounted for, the OLT transmits so-called grants in the form of grant maps to the individual ONTs. A grant map is a permission to use a defined interval of time for upstream transmission. The grant map is dynamically recalculated periodically, such as for each frame. The grant map allocates bandwidth to all the ONTs, such that each ONT receives timely bandwidth allocation for its service needs. Much of the data traffic, such as browsing websites, tends to have bursts and tends to be highly variable over time. By way of a dynamic bandwidth allocation (DBA) among the different ONTs, a PON can be oversubscribed for upstream traffic.

### BRIEF DESCRIPTION OF THE DRAWINGS

For a better understanding of the invention, and to show how the same may be carried into effect, reference will now be made, by way of example, to the accompanying drawings, in which:

FIG. 1 illustrates a network that includes a passive optical network.

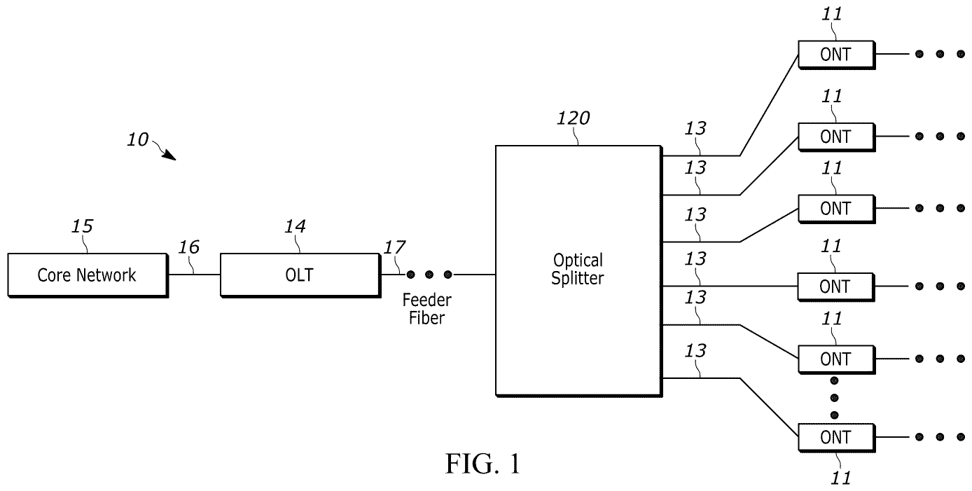

FIG. 2 illustrates a passive optical network with downstream data traffic.

FIG. 3 illustrates a passive optical network with upstream data traffic.

FIG. 4 illustrates a remote OLT.

FIG. 5 illustrates an exemplary OLT.

FIG. 6 illustrates processing for YANG data models using OMCI.

FIG. 7 illustrates processing for PON networks.

FIG. 8 illustrates YANG requests and responses.

FIG. 9 illustrates a PON network with remote OLTs.

FIG. 10 illustrates a PON network with OLTs.

FIG. 11 illustrates failover for OLTs.

FIG. 12 illustrates failover switching.

FIG. 13 illustrates OLT failover.

FIG. 14 illustrates OLT failover distribution.

FIG. 15 illustrates OLT ranging.

FIG. 16 illustrates OLT re-ranging.

### DETAILED DESCRIPTION

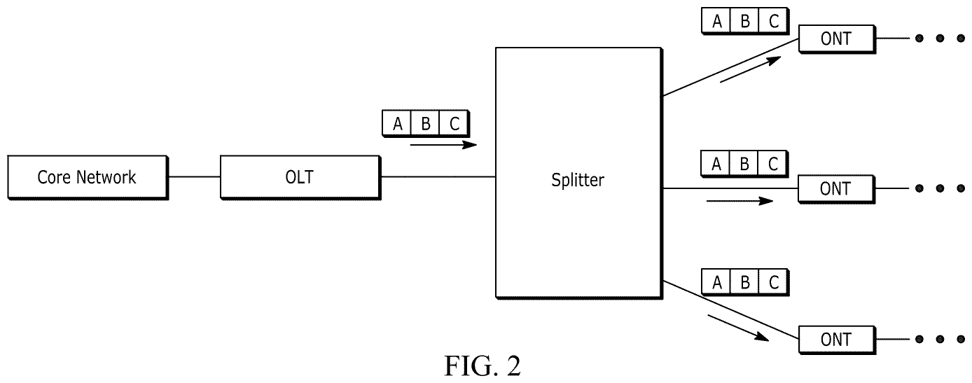

Referring to FIG. 2, the PON network is based upon a point to multi-point downstream transmission arrangement. The data from the OLT is transmitted to all of the ONTs that are interconnected thereto. The data from the OLT is transmitted in the form of one or more frames, where each frame includes data for one or more of the ONTs. For example, in GPON a constant of 125 μs frame is used, where each frame includes (among other control information) an allocation map which informs on the slots granted to allocation ids. Accordingly, each frame is broken up into one or more timeslots that are designated for a corresponding selected one of the ONTs.

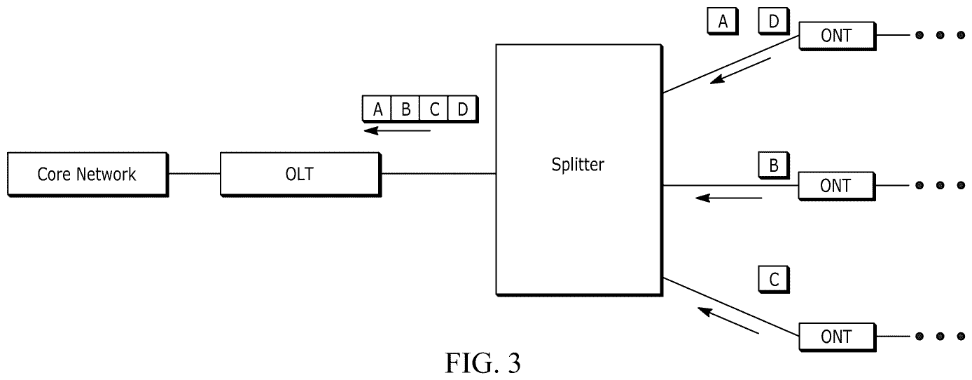

Referring to FIG. 3, the PON network is based upon a multi-point to point upstream transmission arrangement using a time divisional multiple access mechanism. The OLT assigns timeslots (BWmaps) for each ONT to transmit its upstream transmission to ensure a collision free transmission. The data from each of the ONTs is transmitted to the corresponding OLT that it is interconnected thereto. The data from the ONT is transmitted in the form of a portion of one or more frames, where each frame includes data for one or more of the ONTs. For example, in GPON a reference frame of 125 μs frame is used, which is not an absolute value since a round of allocations may span through multiple upstream frames. GPON uses a Generic Encapsulation Method (GEM), which allows for the transport, segmentation and reassembly of Ethernet frames and legacy traffic (ATM or TDM). Accordingly, each frame is broken up into one or more timeslots that are designated for a corresponding selected one of the ONTs.

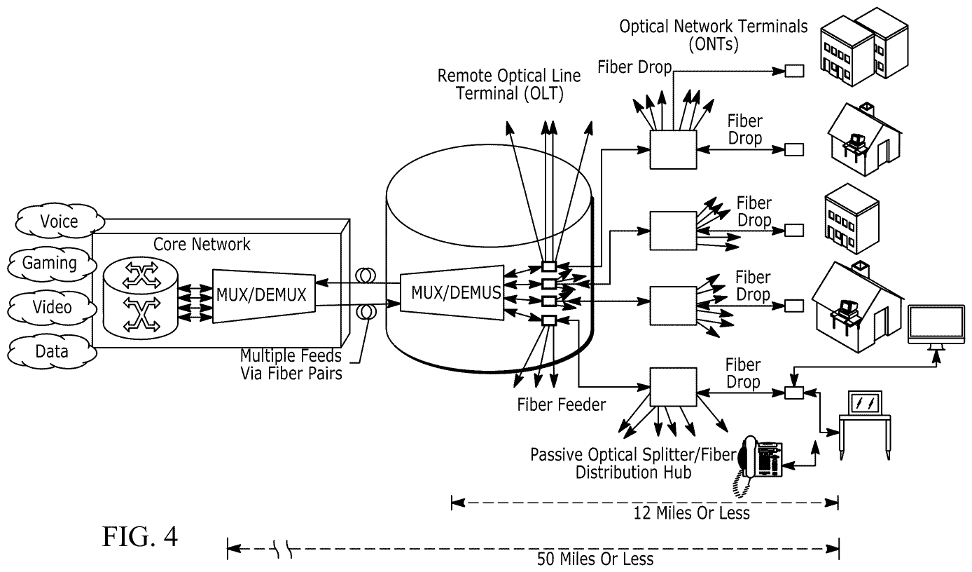

Referring to FIG. 4, it is often desirable in some installations to locate the optical line terminal at a location remote from the core network, generally referred to as a remote optical line terminal (OLT). The remote OLT may include one or more feeds from the core network to the remote OLT. The remote OLT may then distribute data to a plurality of ONTs and receive data from the plurality of ONTs. Each of the ONTs in turn provides data to and receives data from customer devices. The remote OLT typically has the capability of providing services to a few hundred to a few thousand ONTs.

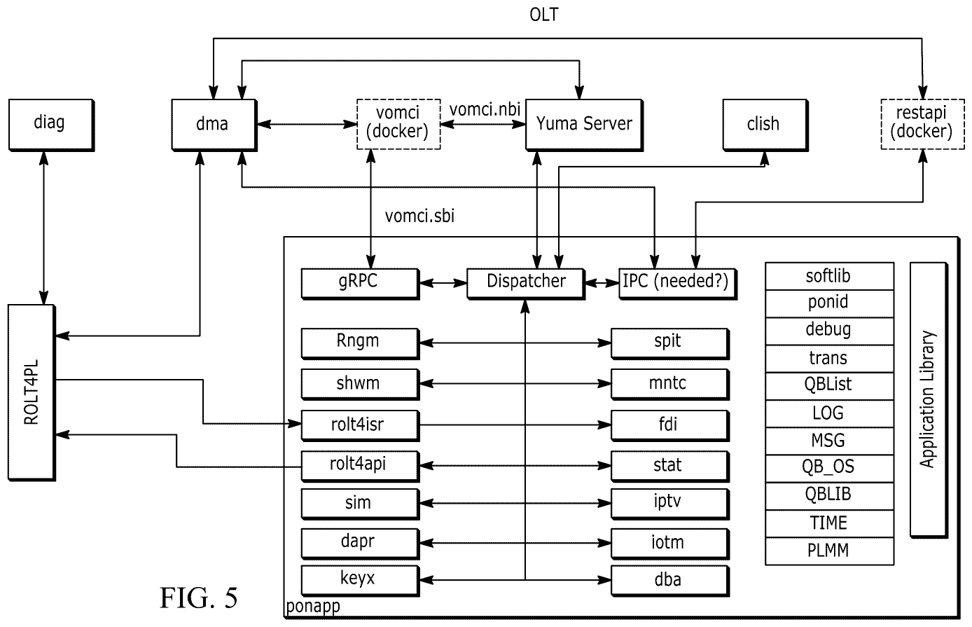

Referring to FIG. 5, an exemplary OLT, which may include a local or a remote OLT, is illustrated. By way of example, a diag process, a dma process, a clish process, a restapi process, a gRPC process, a rolt4isr process, and/or a rolt4api process are preferably included locally on the OLT. Also, a dynamic bandwidth allocation process which allocates available bandwidth among to each of the ONTs is likewise included locally on the OLT. Other processes associated with the remote OLT, such as the vomci and/or Yuma server may be virtualized and located on a cloud based server. For example, the VOMCI may (1) receive service configurations from a virtual OLT management function, (2) translate the received configurations into ITU G.988 OMCI management entities and formatting them into OMCI messages, (3) encapsulating and sending formatted OMCI messages to and from a VOMCI proxy, (4) translating the OMCI messages (presenting ONT's operational data) received from the vOMCI proxy into data (e.g., notifications acknowledges, alarms, PM registers) understandable by the vOLT management function, and/or (5) sending the above ONT operational data to the vOLT management function. See, TR-451 vOMCI Specification, June 2022 and ONT management and control interface (OMCI) specification, G.988, November 2017, both of which are incorporated by reference herein in their entirety.

By way of example, the gRPC provides gRPC server and client layer to interface with multiple vomci agents which may be providing vomci services to the ROLT.

By way of example, the dispatcher provides a messaging pathway between components within the ponapp. Local microservices may register callbacks for message ids which is part of the MSG layer. Any microservice can route to another based on the top 2 bytes of a message id that indicates the destination.

By way of example, the IPC provides TCP and UDP sockets for relaying messages to and from the application in the MSG lib format, and works side by side with the dispatcher.

By way of example, the mgm is a ranging manager that provides the state machine and local for the physical layer management of the ONT. This includes an auto discovery process, the ranging of an ONT, drift management, and LOS handling.

By way of example, the shwm is a shelf manager task that handles any devices that are outside of the rolt4api/rolt4isr domain.

By way of example, the rolt4isr is a handler for incoming interrupts from the PL.

By way of example, the rolt4api handles requests from various microservices in the ponapp to program or interact with the ROLT.

By way of example, the sim provides simulations services to provide the ability to simulate devices that may not be physically present.

By way of example, the spit is a smartcard proxy interface task that provides server for application requests coming in or out of the ponapp. A typical path would be from an outside client via IPC via dispatcher into the spit. The SPIT may then relay to other microservices to perform the requested task. Some provisioning may go via the softlib DB and will be further relayed as a provisioning callout.

By way of example, the mntc is a maintenance state machine which is preferably an event drive state machine for ONTs.

By way of example, the fdi is a fault detection and isolation task as a hierarchical alarm tree service to track alarm conditions for different equipment types.

By way of example, the stat is a statistics manager that handles polling of on board statistics and aggregation of statistics for other calling functions.

By way of example, the iptv provides IPTV services, including IGMP snooping/proxy support.

By way of example, the dapr is a destination address programmer that handles unknown upstream source mac addresses for N:1 connections. This may maintain the mac forwarding table in the PL as well as pruning out aged mac addresses.

By way of example, the iotm is an IOT (aka ONT) manager that suppors directives for the ONT.

By way of example, the dba is a dynamic bandwidth allocation.

By way of example, the keyx is a key exchange task that handles key exchanging for ONTs.

By way of example, the softlib is a soft DB library implemented as a memory based database used to contain configurations of the ROLT.

By way of example, the ponid is a library used to associate ITUT serial numbers with ONT ids and/or channel assignment.

By way of example, the debug is a debug library.

By way of example, the trans is a transaction library used for transactional and state based requests for microservices.

By way of example, the QBList is a library of various list and vector functions.

By way of example, the LOG is an event log.

By way of example, the MSG is a message library.

By way of example, the QB_OS is an operating system library.

By way of example, the QBLIB is a library for local APIs.

By way of example, the TIME is a timer library used for time based callback logic.

By way of example, the PLMM is a ploam message library used for the encoding and decoding of ploam messages on the pon.

The core network and/or the optical line terminals provides management and control functionality over the ONT by using an optical network unit management and control interface (OMCI). The core network 200 and the OLT 210 with which it provides data to and receives data from, transmits data and receives data using a PON protocol over an optical distribution network (e.g., optical splitters, etc.) 220. The OLT 210 passes data through the optical distribution network (ODN) 220 to the ONTs 230, and receives data through the optical distribution network (ODN) 220 from the ONTs 230. The OMCI messages between the ONT 210 and the ONUs 230 for management and control are likewise provided between the OLT 210 and the ONTs 230 through the ODN 22. The ONTs 230 provides access network line termination, a user network interface line termination for subscriber devices, and service multiplexing and de-multiplexing for subscriber devices.

The configuration management provides functions to identify the ONTs capabilities and to exercise control over the ONTs. The areas of management for the ONTs include configuration of, (1) equipment, (2) passive optical network and reach extender protection, (3) the user network interfaces, (4) Gigabit-capable passive optical network Encapsulation Method port network contention termination points; (5) interworking termination points; (6) operations, administration, and maintenance flows, (7) physical ports, (8) Gigabit-capable passive optical network Encapsulation Method adaptation layer profiles, (9) service profiles, (10) traffic descriptors, and (11) asynchronous transfer mode adaptation layer profiles. As modelled by the OMCI, the ONT detects and reports equipment, software, and interface failures and declares the corresponding alarms. The ONTs may be considered as managed entities by the exchange of information between the OLT and the ONT, based upon the OMCI messages for optical access networks.

Each of the functions related to the ONTs capabilities and management are described, to a greater or lesser extent, by various standards in a terse manner that are, typically arrived at by consensus of a diverse set of entities, each of which tends to have a different viewpoint on the meanings of the description in the standards. Accordingly, each of the ONTs and especially those developed by different manufacturers, may have variations based upon the particular manufacturer's interpretation of the various standards. This tends to be especially true for the control and management functions.

The G.988 standard describes managed entities of a protocol-independent management information base (MIB) that models the exchange of information between OLT and ONT in a PON-based access network that are subject to a standard, such as for example, G.988. See, G.988: ONU management and control interface (OMCI) specification, (11/17); G.988 (2017) Amendment 1 (11/18); G.988 ((2017) Amendment 2 (08/19); G.988 (2017) Amendment 3 (03/2); and G.988 (2017) Amendment 4 (09/21), each of which is incorporated by reference herein in its entirety. G.988 also addresses the ONT management and control channel (OMCC) setup, protocol, and message formats. In addition to interpretation considerations by various manufacturers of the G.988 standard, it is also not often sufficient for complete interoperability between different OLT and ONT manufacturers. There exist various ONTs that are simply not compliant with the various standards because of manufacturer decisions on their implementation.

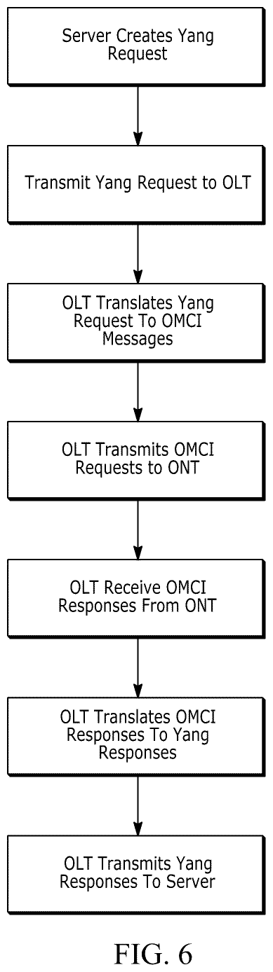

Referring to FIG. 6, one technique to provide an OMCI message to the ONT is for a server at the core network (i.e., any server within the network), to create a virtual OMCI set of microservices that are especially tailored to the functionality for each ONT model of each vendor. The management data maintained by the system is typically defined in terms of YANG data models that comprise modules and submodules that define configuration and state data, notifications, and remote procedure calls for. A YANG module defines a data model through its data, and the hierarchical organization of and constraints on that data. Each module is uniquely identified by a namespace URI. A module defines a single data model. However, a module can reference definitions in other modules and submodules by using the import statement to import external modules or the include statement to include one or more submodules. Additionally, a module can augment another data model by using the augment statement to define the placement of the new nodes in the data model hierarchy and a when statement to define the conditions under which the new nodes are valid. A module uses a feature statement to specify parts of a module that are conditional and the deviation statement to specify where the device's implementation might deviate from the original definition. In this manner, a module can have a large complex set of conditions that accommodate various environments. The core network provides the YANG requests to the OLT which then translates the YANG requests and responses and notifications to and from a vOLTMF (vOLT Management Function) into the OMCI messages, and the OLT transmits and receives the OMCI message requests and responses and notifications to and from the ONT.

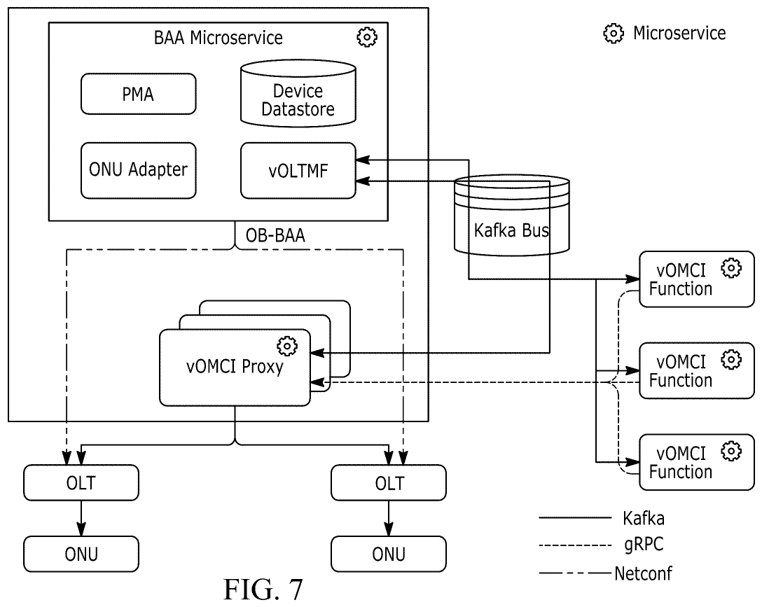

Referring to FIG. 7, a high-level design of a vOLT Management Function (vOLTMF) that may be used to manage ONTs through vOMCI messages is illustrated. There is communication between the vOLTMF, vOMCI Proxy, and vOMCI function based upon creating and deleting ONTs, receiving ont-state-change notifications, and sending requests to ONTs. The vOLTMF manages ONTs through a ONT adapter that may be deployed as broadband access abstraction, the association of which is based on the model, type, vendor, and version mentioned while creating the ONT. The ONT adapter may use a library of the YANG modules for ONTs that the vOLTMF refers to for handling ONT requests, responses, and notifications from external management systems.

The vOLTMF performs actions upon receiving notifications and requests either from an OLT device or other components within the broadband access abstraction core. For example, the onu-state-change notification that is sent by the OLT device on its Northbound Interface (NBI) that is received by broadband access abstraction core. The broadband access abstraction core propagates the notification towards vOLTMF and broadband access abstraction NBI so that it can be handled by the Access SDN M&C.

Upon reception of the notification, the vOLTMF processes the notification, checks if a preconfigured ONU device exists and authenticates the ONU, the vOLTMF transforms the notification to Google Protobufs (GPB) format and propagates the setonu-communication Action towards the vOMCI function and vOMCI-proxy via the Kafka bus.

All the YANG requests are sent towards the vOMCI function and vOMCI Proxy via the Kafka bus in GPB format. Once the vOMCI function/Proxy processes the requests, the vOMCI function sends the notification/request response in GPB format back to the vOLTMF via the Kafka bus and the response is received through the KafkaNotificationCallback#onNotification().

Upon receiving the response, the vOLTMF is responsible for processing the response and performs actions accordingly.

There could be multiple interactions between the vOLTMF and the vOMCI function including parallel configuration requests/commands for either the same or different ONUs. These interactions are parallel and asynchronous such that the requests are not idle/blocked while waiting for responses because the vOLTMF has separate task queues and threadpools to handle the request/response interactions. The following shows the list of vOLTMF threadpools that spawned as new Runnable tasks, namely, processNotificationRequestPool, kafkaCommunicationPool, kafkaPollingPool, processNotificationResponsePool, and processRequestResponsePool. processNotificationRequestPool is used for processing the mediated device event listener callbacks and device notification requests. kafkaCommunicationPool is used to process individual GET/COPY-CONFIG/EDIT-CONFIG requests inside a MediatedDeviceNetconfSession spawned by preocess-RequestResponsePool. kafkaPollingPool is used to tart up the KafkaConsumer implementation and polling for responses from vOMCI-function/vOMCI Proxy. processRequestResponsePool is used for processing notification responses from the vOMCI-function/vOMCI Proxy. The processRequestResponsePool is used for processing GET/COPY-CONFIG/EDIT-CONFIG requests and responses from the vOMCI-function/vOMCI Proxy. In general, the process may be considered a type of protocol adapter to one that operates on an ONT that also works with an OLT in a PON environment. As it may be observed, the manner in which the processing is performed is relatively complex, including Google Protobufs, remote procedure calls, and other complications that require a substantial amount of computational resources to process all the microservices which are burdensome for the OLT.

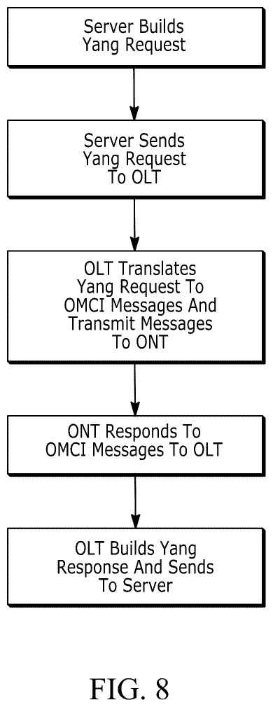

Referring to FIG. 8, in general, the server builds or otherwise selects a YANG request for the ONT. The server then provides the YANG request to the OLT which translates the YANG request to OMCI messages and transmits such OMCI messages to the ONT. The OLT receives OMCI messages from the ONT, and translates them to YANG responses which are provided to the server.

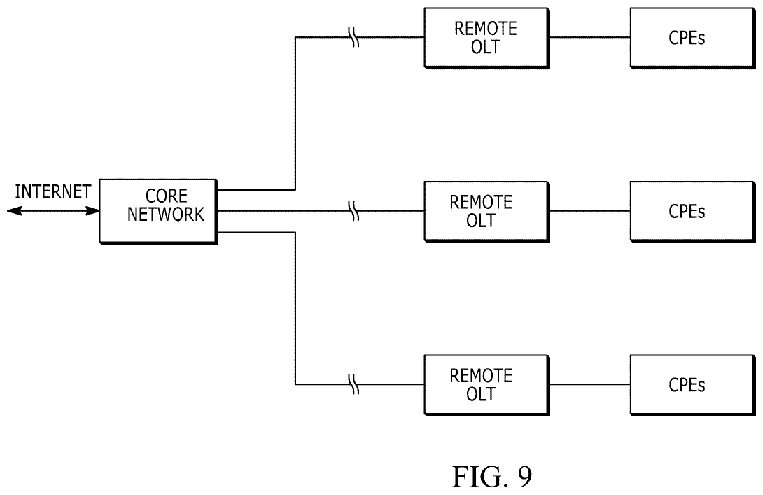

Referring to FIG. 9, in many access networks there are a plurality of remote OLTs that are interconnected to the core network, each of which provides services to a corresponding set of ONTs.

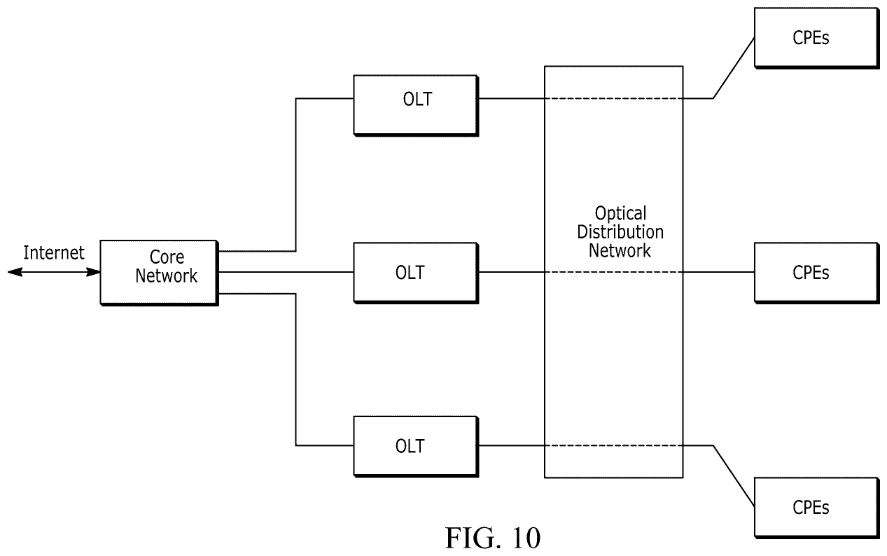

Referring to FIG. 10, in many access networks there are a plurality of OLTs that are co-located and interconnected to the core network, each of which provides services to a corresponding set of ONTs.

The OLT may include a data plane, which controls how data is processed, inclusive of dynamic bandwidth allocation, which are located on the respective OLT. The OLT may include a control plane which provides control over how the data plane processes the data, such as information in a routing table that defines what to do with incoming data. The OLT may include a management plane, that configures, monitors, and provides management, monitor, and configuration services to the control plane and the data plane. The control plane, or portions thereof, for a particular OLT may be virtualized and executed by the core network, with the remaining control plane being executed by the OLT. For example, the vOLT and/or the vOMCI may be virtualized and executed by the corresponding core network. The management plane, or portions thereof, for a particular OLT may be virtualized and executed by the core network, with the remaining management plane being executed by the OLT. The data plane, or portions thereof, for a particular OLT may be virtualized and executed by the core network, with the remaining data plane being executed by the OLT. Preferably, most if not all of the data plane is executed by the OLT. Preferably, most of the control plane is executed by the core network. Preferably, most if not all of the management plane is executed by the core network.

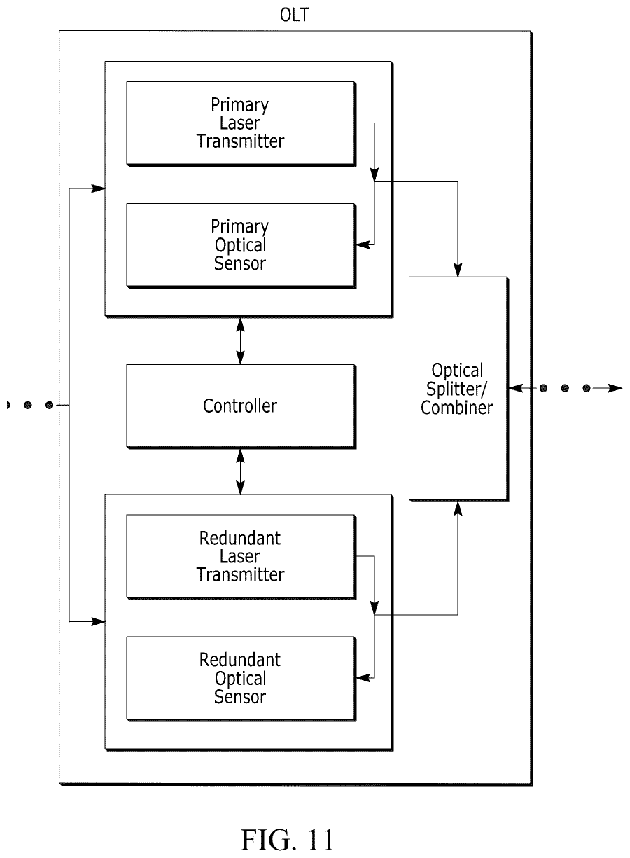

Referring to FIG. 11, in many environments it is desirable to include failover protection for a primary OLT in the event that a primary OLT ceases to provide reliable services to the ONTs by including a redundant OLT, which may be included within the same chassis or within a separate chassis. When the primary OLT ceases providing services including reliable services to the ONTs, the services being provided by the primary OLT may be ceased, and the redundant OLT may be used to provide services to the ONTs. The primary OLT may include a primary laser that provides optical signals to the optical fiber(s) to the ONTs, and a primary optical sensor that senses optical signals from the optical fiber(s) from the ONTs. The redundant OLT may include a redundant laser that provides optical signals to the optical fiber(s) to the ONTs, and a redundant optical sensor that senses optical signals from the optical fiber(s) from the ONTs. When the primary laser is providing signals to the ONTs the redundant laser is not providing signals to the ONTs. Also, when the primary optical sensor is sensing optical signals from the ONTs, the redundant optical sensor is not sensing signals from the ONTs. The optical signals from the primary and redundant lasers to the ONTs may be provided by an optical combiner, and the optical signals to the primary and redundant optical sensors from the ONTs may be provided by an optical splitter. A controller may be used to control which of the primary and redundant components may be used, such as based upon the connectivity with the ONTs. Preferably, the primary laser transmitter/primary optical sensor or the redundant laser transmitter/redundant optical sensor are used, although one of each may be used, depending on the configuration. Preferably the controller is included with the ONT, however, it may also be included as part of the core network. As it may be observed, the primary and redundant optical paths share the same optical fibers from the optical combiner and/or optical splitter to the ONTs, and which have separate optical fibers from the respective laser and optical sensor to the optical splitter/combiner, respectively. The input to the OLT from the core network is preferably an Ethernet packet based inter-connection.

When the primary OLT ceases to properly operate or otherwise the respective ONTs do not properly communicate with the primary OLT, the operator of the network may selectively disable the primary OLT and enable the redundant OLT to provide services to the ONTs, such as by signaling the controller. Preferably, the controller and/or the core network determines that the primary OLT ceases to properly operate or otherwise the respective ONTs do not properly communicate with the primary OLT, selectively disables the primary OLT and enables the redundant OLT to provide services to the ONTs. Also, the controller and/or the core network may determine that the redundant OLT ceases to properly operate or otherwise the respective ONTs do not properly communicate with the redundant OLT, selectively disables the redundant OLT and enables the primary OLT to provide services to the ONTs.

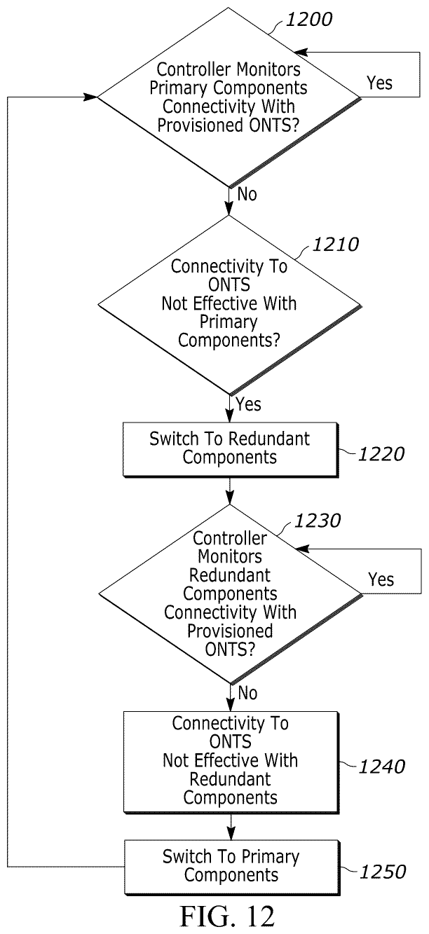

Referring to FIG. 12, the source of the failure can result from many different sources, such as the primary components, the redundant components, the optical fiber from the primary components to the optical splitter/combiner, the optical fiber from the redundant components to the optical splitter/combiner, one of the primary components (e.g., primary laser transmitter or primary optical sensor), one of the redundant components (e.g., redundant laser transmitter or redundant optical sensor), portions of the optical splitter/combiner, control components for the primary laser transmitter or primary optical sensor, and/or control components for the redundant laser transmitter or redundant optical sensor. To provide more effective data connectivity with devices, the controller may monitor whether the primary components are effectively communicating with some or all of the ONTs that are provisioned on the passive optical network for the corresponding optical line transmitter 1200. If the data connectivity to the ONTs with the primary components is not effective 1210, such as some or all of the provisioned ONTs are unavailable, the controller switches communication to the ONTs using the redundant components while turning off the primary components 1220. The controller may monitor whether the redundant components are effectively communicating with some or all of the ONTs that are provisioned on the passive optical network for the corresponding optical line transmitter 1230. The controller preferably monitors whether the redundant components are effectively communicating with some or all of the ONTs that are provisioned for a time period, preferably greater than 5 seconds, preferably greater than 10 seconds, more preferably greater than 20 seconds, and more preferably greater than 30 seconds. If the controller determines, after an elapsed time period, that the connectivity with the provisioned ONTs is no effective using the redundant components 1240, such as some or all of the provisioned ONTs are unavailable, the controller switches communication to the ONTs using the primary components while turning off the redundant components 1250. The controller preferably monitors whether the primary components are effectively communicating with some or all of the ONTs that are provisioned for a time period 1200, preferably greater than 5 seconds, preferably greater than 10 seconds, more preferably greater than 20 seconds, and more preferably greater than 30 seconds. Accordingly, the controller manages the switching between the primary components and the redundant components, with a temporal time delay between the switching, until such a time that effective communication is established with the corresponding ONTs.

The controller may include, for example, a field programmable gate array (FPGAs) that includes blocks of gates that can be configured to implement the logic. In comparison, a microprocessor is a central processing unit (CPU) that executes a program that contains a specific set of instructions. Microprocessors have a fixed set of instructions which are used for an appropriate program generally referred to as programming code. Each of these instructions has its own corresponding block or blocks hardwired into the microprocessor. The FPGA in comparison does not have such hardwired logic blocks. The FPGA is often laid out like a net with each junction containing a switch that can be made or break. This set of interconnections determines how the logic of each block is determined. Programming the FPGA typically involves a hardware description language, generally referred to as programming logic. In some cases, the FPGA and the microprocessor are combined within a single package that provides added flexibility. The microprocessor typically does most of the generalized processing while passing off more specific tasks to the FPGA gate array. For the OLT, the combination of the microprocessor and the FPGA gate array within a single package (i.e., chip) based processing system provides programming flexibility together with particularized logic processing that is especially suitable for supporting reduced power usage limitations.

The controller, including the processing system (e.g., FPGA and microprocessor based chip), preferably includes most of the data plane processing inclusive of the dynamic bandwidth allocation. The controller may include portions of the control plane and/or management plane, while the majority the control plane and/or management plane is virtualized and provided by the core network.

By way of example, most of the processing side of the processing system is preferably virtualized to a computing device (e.g., core network) external to the OLT. Preferably, the virtualized processing side of the processing system is primarily related to the control pane, inclusive of the majority of the vOMCI and the vOLT. Most of the programming logic of the processing system is preferably data plane processing for the OLT, while a portion thereof may be virtualized to a computing device (e.g., core network). Preferably, the programming logic of the processing system is primarily related to the data plane. In particular, it is desirable to include the dynamic bandwidth allocation process to be included within the processing system, and not virtualized.

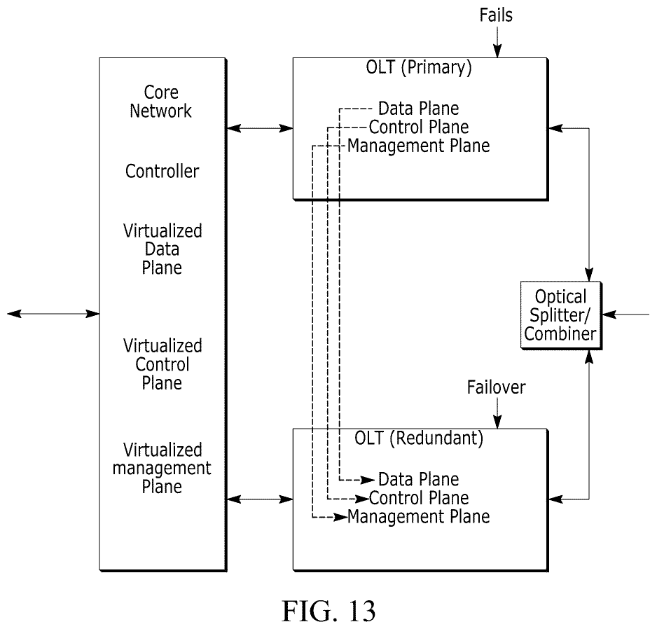

Referring to FIG. 13, in one embodiment, the access network for the passive optical network typically includes a set of OLTs, each of which includes localized processing capabilities, such as a FPGA, microprocessor, and/or processing system. Also, a portion of the processing required for each of the OLTs (e.g., data plane, control plane, and/ or management plane) may be provided as a virtualized service on the core network. In the case that a primary OLT providing services to the respective ONTs is replaced by a redundant OLT providing services to the respective ONTs, the virtualized services provided by the core network may be provided to the redundant OLT. In this manner, the redundant OLT may re-use existing data from the primary OLT to reduce the computational burden on the redundant OLT.

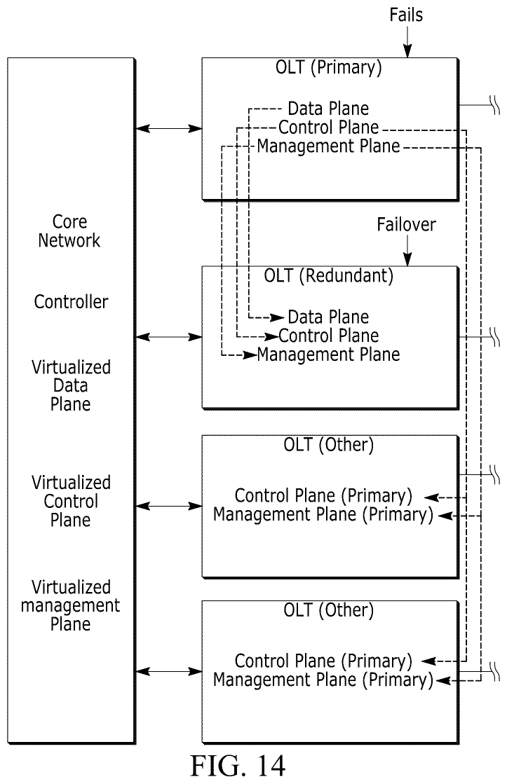

Referring to FIG. 14, in another embodiment, the access network for the passive optical network typically includes a set of OLTs, each of which includes localized processing capabilities, such as a FPGA, microprocessor, and/or processing system. Also, a portion of the processing required for each of the OLTs (e.g., data plane, control plane, and/or management plane) may be provided as a virtualized service on the core network. In the case that a primary OLT providing services to the respective ONTs is replaced by a redundant OLT providing services to the respective ONTs, the services provided replaced primary OLT may be provided by the redundant OLT. Also, in the case that a primary OLT providing services to the respective ONTs is replaced by a redundant OLT providing services to the respective ONTs, the services provided replaced primary OLT may be provided by other OLTs within the network, as processing capabilities are available. In this manner, the collection of OLTs may collectively provide redundant and processing capabilities for other OLTs, with at least some of the services for a particular OLT being provided by another OLT.

There are different distances between OLT and ONTs due their physical location relative to one another. The different distances results in different times being required for an optical signal from the OLT to reach the ONT and for optical signals from the ONT to reach the OLT. Ranging may be used reduce the collisions of data for the different ONTs. For example, a ranging technique may allow adjustment of the timing between the OLT and each of the ONTs, where each of the ONTs may have a different temporal range offset. The OLT sends specific grants to activate ranging and opens up a window to receive responses from the ONT. The ONT is sending a ranging call back to the OLT, after receiving the grant. The OLT is assigning an equalization delay to a specific ONT, based on the elapsed time between sending ranging grant and receiving response.

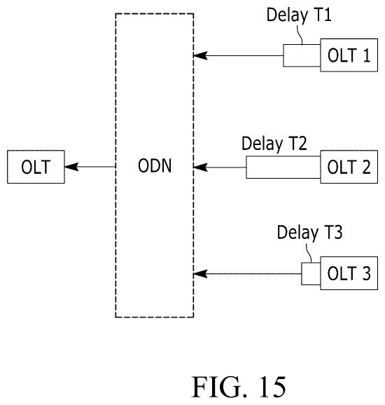

Referring to FIG. 15, in order to avoid upstream transmission collision between many ONTs, ranging is necessary. Since ONTs are located at different distances from the OLT, data should arrive in the correct time slots at the OLT, to reduce errors. Ranging mechanism creates transmission delay of the necessary length. Ranging is initiated by sending ranging request message from the OLT to a particular ONT. Based on the reply and RTD (Round-Trip-Delay) the equalization delay is calculated. Then this information is forwarded towards ONT. Now the ONT is located on the same virtual distance from OLT as the other ONTs. The ranging is performed for all of the corresponding ONTs. Due to ranging, the data should have no transmission conflicts. However, the time to perform the ranging for all of the corresponding ONTs is substantial because the ONTs tend to transmit at the same time requiring backing off selected ONTs while other ONTs transmit, and so forth, until all of the ONTs have been ranged.

For the primary OLT, there is a distribution of ranging times that are determined and provided to the corresponding ONTs. Periodically, due to changes in temperature and other variations over time, the OLT will re-range selected ONTs and selectively update the ONT with the updated ranging information. When the primary OLT fails or is otherwise not providing effective communications with the ONTs, the system switches to the redundant OLT. The redundant OLT, even with seemingly the same effective optical distance to the OLTs, is not suitable to directly use the ranges used by the primary OLT because the ranging information tends to sufficiently different. Further, even the relative differences in the ranging information of the primary OLT are not suitable to be directly used by the redundant OLT because even the relative differences in the ranging information for the OLT tends to be sufficiently different for at least some of the OLTs.

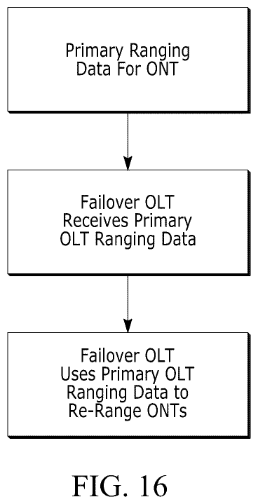

Referring to FIG. 16, while the primary OLTs ranging is not sufficiently accurate for the redundant OLTs ranging, it is sufficient to provide useful information that may be used for ranging by the redundant OLT. By way of example, the redundant OLT may select a subset of the ONTs to re-range, such as those that are likely not to conflict with one another. By way of example, the redundant OLT may select a set of ONTs that have sufficiently different ranging values so that sufficient temporal spacing exists between the ranging. The remaining ONTs are likely to have generalized offsets from the ranged set of ONTs by the redundant OLT based upon the offsets of the primary OLT. For example, if ONT 15 has a range value of 1000 for the primary OLT, it may have a range value of 1004 for the redundant OLT. For example, if ONT 16 is determined to have a range value of 1003 (+3 relative to ONT 15), the redundant OLT may initially estimate that ONT 16 will likely have a range of generally 1007 (1004+3 relative to ONT 15). The redundant OLT may estimate the ranging for the remaining ONTs based upon the initial set of ranging of one or more ONTs. Based upon the estimate of the remaining ONTs (or a set thereof), the redundant OLT may select a set of, or the remaining, ONTs to range together with a spacing between sending out the requests for ranging to the selected ONTs so that the likelihood of the ONTs interfering with one another during the ranging is substantially reduced. The redundant OLT may continue this process until all of the ONTs are ranged. The selective use of the ranging information from the primary OLT for the redundant OLT, together with timing of the ranging requests, the time necessary for performing the ranging is substantially reduced.

Other techniques may likewise be used that use the ranging information from the primary OLT to inform the ranging information for the redundant OLT to reduce the time for performing such ranging.

Moreover, each functional block or various features in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. An access network for a passive optical network comprising:
(a) a first optical line terminal includes a north bound interface that is capable of receiving and sending data from and to a server, respectively;
(b) said first optical line terminal includes a port that is capable of receiving and sending optical data from and to a set of optical network terminals, respectively, through an optical fiber;
(c) a second optical line terminal includes a north bound interface that is capable of receiving and sending data from and to said server, respectively;
(d) said second optical line terminal includes a port that is capable of receiving and sending optical data from and to said set of optical network terminals, respectively, through said optical fiber;
(e) a controller that determines whether one of said first optical line terminal and said second optical line terminal currently attempting to send and receive said optical data is not effectively communicating with one of said optical network terminals, and in response thereto, switching to the other of said first optical line terminal and said second optical line terminal to attempt to send and receive said optical data with one of said optical network terminals, and said controller determining said switching based upon, at least in part, monitoring said effective communication during a temporal time period of at least 5 seconds.

2. The access network of claim 1 further comprising said temporal time period being at least 10 seconds.

3. The access network of claim 1 further comprising said temporal time period being at least 20 seconds.

4. The access network of claim 1 further comprising said temporal time period being at least 30 seconds.

5. The access network of claim 1 further comprising said controller determining said other of said first optical line terminal and said second optical line terminal currently attempting to send and receive said optical data is not effectively communicating with one of said optical network terminals, and in response thereto, switching to the other of said first optical line terminal and said second optical line terminal to attempt to send and receive said optical data with one of said optical network terminals, and said controller determining said switching based upon, at least in part, monitoring said effective communication during a temporal time period of at least 5 seconds.

6. An access network for a passive optical network comprising:
(a) a first optical line terminal includes a north bound interface that is capable of receiving and sending data from and to a server, respectively;
(b) said first optical line terminal includes a port that is capable of receiving and sending optical data from and to a first set of optical network terminals, respectively, through a first optical fiber;
(c) a second optical line terminal includes a north bound interface that is capable of receiving and sending data from and to said server, respectively;
(d) said second optical line terminal includes a port that is capable of receiving and sending optical data from and to said first set of optical network terminals, respectively, through said first optical fiber;
(e) a third optical line terminal includes a north bound interface that is capable of receiving and sending data from and to said server, respectively;
(f) said third optical line terminal includes a port that is capable of receiving and sending optical data from and to a second set of optical network terminals, respectively, through a second optical fiber, where none of said first set of optical network terminals are included in said second set of optical network terminals;
(g) a controller that determines whether one of said first optical line terminal and said second optical line terminal currently attempting to send and receive said optical data is not effectively communicating with one of said optical network terminals, and in response thereto, switching to the other of said first optical line terminal and said second optical line terminal to attempt to send and receive said optical data with one of said optical network terminals, and said access network relocating, at least a part of, at least one of control plane processes and management plane processes provided by said first optical line terminal to said third optical line terminal.

7. The access network of claim 6 wherein said access network relocating, at least a part of, both said control plane processes and management plane processes provided by said first optical line terminal to said third optical line terminal.

8. An access network for a passive optical network comprising:
(a) a first optical line terminal includes a north bound interface that is capable of receiving and sending data from and to a server, respectively;
(b) said first optical line terminal includes a port that is capable of receiving and sending optical data from and to a first set of optical network terminals, respectively, through a first optical fiber;
(c) a second optical line terminal includes a north bound interface that is capable of receiving and sending data from and to said server, respectively;
(d) said second optical line terminal includes a port that is capable of receiving and sending optical data from and to said first set of optical network terminals, respectively, through said first optical fiber;
(e) a controller that determines whether one of said first optical line terminal and said second optical line terminal currently attempting to send and receive said optical data is not effectively communicating with one of said optical network terminals, and in response thereto, switching to the other of said first optical line terminal and said second optical line terminal to attempt to send and receive said optical data with one of said optical network terminals, and said server including virtualized control plane services for said first optical line terminal that are switched to provide virtualized control plane services for said second optical line terminal.

9. The access network of claim 8 further comprising said server including virtualized management plane services for said first optical line terminal that are switched to provide virtualized control plane services for said second optical line terminal.

10. An access network for a passive optical network comprising:
(a) a first optical line terminal includes a north bound interface that is capable of receiving and sending data from and to a server, respectively;
(b) said first optical line terminal includes a port that is capable of receiving and sending optical data from and to a set of optical network terminals, respectively, through an optical fiber;
(c) a second optical line terminal includes a north bound interface that is capable of receiving and sending data from and to said server, respectively;
(d) said second optical line terminal includes a port that is capable of receiving and sending optical data from and to said set of optical network terminals, respectively, through said optical fiber;
(e) a controller that determines whether one of said first optical line terminal and said second optical line terminal currently attempting to send and receive said optical data is not effectively communicating with one of said optical network terminals, and in response thereto, switching to the other of said first optical line terminal and said second optical line terminal to attempt to send and receive said optical data with one of said optical network terminals, and said second optical line terminal re-ranging said set of optical network terminals based upon ranging data from said first optical line terminal.

11. The access network of claim 10 wherein said second optical line terminal re-ranges at least one of said optical network terminals of said set of optical network terminals and uses a change in the ranging of said one of said optical network terminals between said first optical network terminal and said second optical network terminal to modify the timing of the re-ranging of other ones of said set of optical network terminals.
